(19) United States
(12) Patent Application Publication
(10) Pub. No.: US 2005/0008748 A1
(43) Pub. Date: Jan. 13, 2005

(54) Biscuit extrudable at negative temperature, process of preparation and use in composite ice confectionery products

(76) Inventor: Christian Dufort, Nontron (FR)

Correspondence Address: WINSTON & STRAWN;PATENT DEPARTMENT, 1400 L STREET, N.W., WASHINGTON, DC, 20005-3502, US

(21) Appl. No.: 10/899,049

(22) Filed: Jul. 27, 2004

Related U.S. Application Data
(63) Continuation of application No. PCT/EP03/01072, filed on Feb. 4, 2003.

(30) Foreign Application Priority Data
Apr. 23, 2002 (EP) 02076610.1

(51) Int. Cl. A21D 10/00

(52) U.S. Cl. 426/549

(57) ABSTRACT

A reconstituted biscuit extrudable at negative temperature, comprising: hard or soft type baked biscuit pieces which have been frozen beforehand, and a dispersion binder for the said biscuit pieces in the form of a meringue with overrun comprising an overrun-promoting protein chosen from egg white and egg white substitutes of milk origin and carbohydrates, frozen at about −5° C. Composite ice confectionery article comprising an assembly of the extruded biscuit and a frozen confectionery mass in contact with this biscuit. Process for preparing such a biscuit.

### CROSS-REFERENCE TO RELATED APPLICATIONS

This application is a continuation of International application PCT/EP03/01072 filed Feb. 4, 2003, the entire content of which is expressly incorporated herein by reference thereto.

### BACKGROUND ART

The invention relates to the field of biscuit manufacture and more particularly the field of biscuit manufacture adapted to composite ice confectionery in which an ice confectionery mass is combined with a biscuit.

Numerous products of the ice confectionery type comprising biscuit exist. They may be for example ice cakes comprising alternating layers of ice confectionery, that is to say of ice-cream or of sorbet and biscuit.

The biscuit used may be a relatively dry, crumbly and crunchy biscuit of the butter biscuit or shortbread type, called hard biscuit, or of the wafer type, manufactured from a liquid dough. These types of biscuit have good crunchiness and can be easily formed. After assembling the ice confectionery and the biscuit, the product is stored in the frozen state. However, during storage and distribution, the biscuit tends to take up moisture, both from the ice confectionery and from the external environment. This moisture uptake is damaging to the organoleptic qualities of the biscuit, the latter becoming soft.

Another form of pastry is known which is combined with ice confectionery, the so-called “genoese” type soft, spongy, aerated and supple biscuit. Such a biscuit is generally prepared from a liquid dough poured into flat molds, baked and cut, and then cooled to constitute the bases for ice cakes. The usefulness of such types of biscuit is to be compatible with ice-cream since it is not very sensitive to moisture uptake during storage in the frozen state. The main disadvantage linked to the use of this type of biscuit is the difficulty of handling it: it cannot be formed and extruded, in particular, at the same time as the ice confectionery.

An ice cake of the latter type is described for example in EP-A-40349 relating to the manufacture of an ice cake of the Norwegian omelette type consisting of a rectangular layer of separately prepared genoese serving as support, which is topped with a vanilla ice-cream core, the core itself being surrounded by a meringue egg white decoration. Despite this disclosure, there still remains a need for improvements in the manufacture and structure of such products.

### SUMMARY OF THE INVENTION

The invention provides a supple biscuit-based pastry raw material which is extrudable at negative temperature, which, when it is used in combination with ice confectionery to prepare composite ice confectionery products, allows the production, at industrial throughput, of composite products having an attractive visual appearance linked to a textural effect that contrasts with the ice confectionery.

In particular, the invention relates to a reconstituted biscuit extrudable at negative temperature, which comprises:
hard or soft type baked biscuit pieces which have been frozen beforehand, and
a dispersion binder for the biscuit pieces in the form of a meringue with overrun comprising an overrun-promoting protein chosen from egg white and egg white substitutes of milk origin and carbohydrates, frozen at a negative temperature ranging from −3° C. to −8° C.,
wherein the mixture of biscuit pieces and dispersion binder has an overrun of 80 to 150%.

The invention also relates to a composite ice confectionery comprising a biscuit according to the invention in contact with an ice confectionery mass.

Also, the invention further relates to a process for manufacturing this reconstituted biscuit and composite ice confection.

### DETAILED DESCRIPTION OF THE PREFERRED EMBODIMENTS

The expression “biscuit pieces” is understood to mean hard or preferably soft baked biscuit particles obtained after cutting a frozen genoese mass into cubes. For measuring these particles, they can be inscribed in a sphere. The random distribution of the particles is such that at least about 60% of these particles have a mean diameter of the sphere where they are inscribed of between 1 and 4 mm, and preferably at least about 90% of them have a mean sphere diameter of between 1 and 3 mm.

The carbohydrates entering into the composition of the dispersion binder may be chosen from the group consisting of sucrose, maltodextrin and glucose syrup, and these are preferably used in the form of a mixture. Thus, the binder may comprise from about 20 to 30% by weight of sucrose and about 8 to 15% by weight of glucose syrup relative to the total wet weight.

The dispersion binder contains an overrun-promoting protein which may be egg white or a milk protein. Preferably, it contains a whey protein isolate rich in alpha-lactalbumin or a partially hydrolysed milk protein based on caseinate. To obtain the desired overrun effect, about 1 to 5% weight of egg or milk protein is preferably used relative to the total wet weight of the binder.

The binder may also contain a texturing, thickening or gelling agent such as gelatin, a carrageenan gum or a mixture of carrageenan gum and starch as a gelatin substitute. The texturing agent is preferably used at an amount of 0.5 to 2% by weight, relative to the total wet weight of the binder.

Finally, the binder may contain a flavoring agent of the type conventionally used in biscuit manufacture, such as cocoa powder, spices or dry fruits.

The extrudable reconstituted biscuit according to the invention has a number of specific advantages:
it has a nonbrittle, supple texture,
it can be formed or metered in the same manner as the extruded ice confectionery,
it adheres perfectly to the ice confectionery,
it can be manufactured at industrial throughput,
the dispersion binder may be frozen and given a degree of overrun in a freezer, that is to say with the same equipment as the ice confectionery.

One preferred use of the biscuit according to the invention is as part of a composite ice confectionery that includes an ice confectionery mass in contact with this biscuit.

The expression “ice confectionery mass” is mainly understood to mean an ice composition based on a dairy product such as an ice-cream proper or an extruded sorbet. This ice confectionery mass is generally given a degree of overrun of 80-120% by volume. This ice confectionery mass may consist of an ice-cream or a sorbet or of several ice-creams or sorbets with different flavors and may contain inclusions, for example of sauce, syrup, fatty composition, for example chocolate in the form of small pieces, sheets or chips or small pieces of dry or candied fruits.

The assembling of the biscuit with the ice confectionery may be carried out by coextrusion or by successive extrusion of biscuit layers or zones and of ice confectionery. Because the biscuit mass has properties of plasticity similar to those of the ice confectionery, the biscuit can be easily formed into all the shapes which can be produced for the extruded ice confectionery.

It is possible to produce, for example, composite articles such as ice sticks or bars or portions in the form of composite slices of the “cassata” type or of domes, for example. In these articles, the biscuit may constitute the core or the coating.

It is possible to produce, for example, cakes consisting of alternate superposed layers of biscuit and of ice confectionery.

The biscuit mass may, for example, be continuously extruded in the form of a base layer on a conveyor belt and the ice confectionery mass(es) extruded in the form of a roll on the biscuit to constitute an assembly and the assembly may then be cut into portions.

The cake may have on its top surface and/or on its sides attractive decorative elements, for example, of additions or may be in the form of a coating, of bands, of wavy lines or in chequered form made of a fatty composition, for example of chocolate or of covering or a sweetened composition for icing, flavored and colored, conferring a visual and taste contrast with the ice confectionery mass. The decoration may be made on the continuous assembled band at the same time as the extrusion before cutting the portions or on the cut portions.

Using the biscuit mass formulation according to the invention, the ice confectionery obtained has the advantage of a textural contrast between the creaminess and the meltingness of the ice confectionery mass and the softness of the biscuit, even after prolonged storage at freezing temperature, that is to say a temperature of less than −10° C., and preferably less than −18° C.

A process for manufacturing the preceding reconstituted biscuit can include the following steps:
the texturing agents and the carbohydrates are mixed in water successively or together and heated until dissolution is obtained and are pasteurized,
an overrun-promoting protein is added to the preceding mixture, and in the case of an overrun-promoting protein of milk origin, this addition may be carried out before pasteurization, so as to prepare a dispersion binder,
the dispersion binder is frozen and given a degree of overrun in a freezer, and
a hard or soft biscuit mass, cooled and cut into pieces, is incorporated into the frozen binder with overrun.

### EXAMPLES

The examples below illustrate the invention. In these examples, the parts and percentages are by weight, unless otherwise stated.

### Example 1

Manufacture of a biscuit containing egg white and of a composite ice cake

Preparation of the meringue

The ingredients indicated are used in the proportions indicated below:

| Ingredient | % |
|---|---|
| Crystal sucrose | 27.6 |
| Dehydrated glucose syrup | |
| (DE: 36-40) | 10 |
| Vanilla flavor | 0.18 |
| Gelatin (bloom 210-230) | 1.2 |
| Powdered egg white | 3.5 |
| Water | Balance for 100 |

DE: dextrose equivalent

Water is heated in a tank provided with a stirrer and a jacket at 70° C., and then the gelatin premixed with 4 times its weight of crystal sucrose is dissolved therein and the mixture is stirred until complete dissolution is obtained. The remainder of the sucrose and the dehydrated glucose syrup are then added to the mixture, with stirring. The temperature of the mixture is raised to 85° C. and this temperature is maintained for 5 min. The mixture is then cooled to 40° C.

The powdered egg white is added at this temperature, with slow stirring until complete dissolution is obtained. The mixture is then cooled to 10° C. At the time of use, the mix is frozen and given an overrun of 175% by volume in a freezer. On coming out of the freezer, the meringue composition is at −5° C.

Preparation of the extruded biscuit

A genoese biscuit is cut into cubes having 10 mm edges in an URSCHEL machine and the pieces are frozen. The frozen genoese pieces are distributed with the aid of a DOSAPRO metering screw in the stream of the meringue composition coming from the freezer and all the pieces and the meringue composition are mixed in the mixing screw of an “ingredient feeder”, the mixture being produced vertically from bottom to top and being conveyed towards a tube connected to an extruder with a flat nozzle.

Manufacture of the cake

An ice cake is manufactured from the preceding biscuit and an ice-cream mass having an overrun of 100% by volume, frozen in a freezer at an outlet temperature of −5° C. and has the composition below:

| Ingredient | % |
|---|---|
| Powdered milk | 10 |
| Emulsifier (CREMODAN ®) | 0.5 |
| Vanilla flavour | 0.5 |
| Hydrogenated vegetable fat | 8 |
| Sucrose | 14 |
| Glucose syrup | 4 |
| Water | Balance for 100. |

To do this, the flat nozzle is mounted fixed above a continuous conveyor belt, parallel to the belt on which a ribbon of biscuit is deposited by extrusion from this nozzle. An ice-cream mass in the form of a decorative rolled up ribbon is then deposited on the biscuit by means of a revolving joint extruder provided with a flat nozzle ending with an outlet tip in the form of a slit which is symmetrical relative to the axis of rotation of the nozzle. In this manner, by adjusting the speed of rotation of the mobile nozzle and the speed of passage of the belt, a rolled up, folded ribbon is obtained. The composite ribbon is finally cut into portions which constitute the cake. The portions are placed in a hardening tunnel, wrapped and stored at a temperature <−18° C.

### Example 2

Manufacture of a biscuit containing milk proteins and a composite ice cake

Preparation of the chocolate meringue

The ingredients indicated are used in the proportions indicated below:

| Ingredient | % |
|---|---|
| Crystal sucrose | 21.7 |
| Dehydrated glucose syrup (DE: 40) | 16 |
| Maltodextrin (DE: 8-10) | 3 |
| Fine salt | 0.05 |
| Overrun-promoting milk proteins | 1.2 |
| of the calcium caseinate type | |
| (BV 50 DMV International) | |
| Defatted cocoa powder | 3 |
| (10-12% of fat) | |
| Xanthan gum (Rhodigel easy Z) + instant | 1.47 |
| starch | |
| Iota-carregeenan | 0.33 |
| Mono-diglyceride emulsifier | 0.2 |
| (CREMODAN 60 VEG) | |
| Water | Balance for 100 |

DE: dextrose equivalent

Xanthan gum and starch are mixed in cold water, and then the mixture is heated in a tank provided with a stirrer and a jacket at 65° C., then a premixture containing crystal sucrose, maltodextrin, fine salt, glucose syrup, iota-carrageenan, cocoa powder and the emulsifier is dissolved therein until complete dissolution is obtained, with vigorous stirring. The powdered milk proteins are then added to the mixture at this temperature, with slow stirring until a good dispersion is obtained. The temperature of the mixture is increased to 85° C. and this temperature is maintained for 5 min in order to pasteurize it. The mixture is then cooled to 10° C. At the time of use, the mix is frozen and it is given an overrun of 180% by volume in a freezer. On coming out of the freezer, the meringue composition is at −5° C.

Preparation of the extruded biscuit

A genoese biscuit is cut into cubes having 10 mm edges in an URSCHEL machine and the pieces are frozen. The frozen genoese pieces are distributed directly into the frozen stream of the meringue composition coming from the freezer by the mixing screw of an “ingredient feeder”, the mixture being produced vertically from bottom to top and being conveyed towards a tube connected to an extruder with a flat nozzle. The biscuit has an overrun of 130% by volume.

Manufacture of the cake

An ice cake is manufactured from the preceding biscuit and an ice-cream mass having an overrun of 100% by volume, frozen in a freezer at an outlet temperature of −5° C. and has the composition below:

| Ingredient | % |
|---|---|
| Powdered milk | 10 |
| Emulsifier (CREMODAN ®) | 0.5 |
| Vanilla flavour | 0.5 |
| Hydrogenated vegetable fat | 8 |
| Sucrose | 14 |
| Glucose syrup | 4 |
| Water | Balance for 100. |

To do this, the flat nozzle is mounted above a conveyor belt, on which a ribbon of biscuit is deposited by extrusion from this nozzle. An ice-cream mass in the form of a flat ribbon is then deposited on the biscuit by a flat nozzle and these successive depositions are repeated in order to obtain a band comprising three layers of biscuit and two layers of ice-cream between the layers of biscuit. The composite ribbon thus obtained is then cut into portions and the portions are coated with a chocolate covering, which constitutes the cake.

1. A reconstituted biscuit extrudable at negative temperatures, which comprises a mixture of:
hard or soft baked biscuit pieces which have been frozen beforehand, and
a dispersion binder for the biscuit pieces comprising a meringue that is overrun and that includes a meringue comprising an overrun-promoting protein chosen from
(a) egg white or egg white substitutes of milk origin and
(b) carbohydrates, with the binder being frozen at a negative temperature ranging from −3° C. to −8° C.,
wherein the mixture of biscuit pieces and dispersion binder has an overrun of 80 to 150%.

2. Biscuit according to claim 1, in which the biscuit pieces are particles whose random distribution is such that at least about 60% of these particles have a mean diameter of a sphere in which they are inscribed of between 1 and 4 mm.

3. Biscuit according to claim 1, in which at least about 90% of the biscuit pieces have a mean sphere diameter of between 1 and 3 mm.

4. Biscuit according to claim 1, in which the carbohydrates entering into the composition of the dispersion binder are chosen from the group consisting of sucrose, maltodextrin, glucose syrup, and a mixture thereof.

5. Biscuit according to claim 4, in which the binder comprises from about 20 to 30% by weight of sucrose and about 8 to 15% by weight of glucose syrup relative to the total wet weight of the binder.

6. Biscuit according to claim 1, in which the overrun-promoting protein of the dispersion binder is a whey protein isolate rich in alpha-lactalbumin or a partially hydrolysed milk protein based on caseinate.

7. Biscuit according to claim 1, wherein the overrun-promoting protein is present in an amount of about 1 to 5% by weight, relative to the total wet weight of the binder.

8. Biscuit according to claim 1, wherein the binder further comprises a texturing, thickening or gelling agent.

9. Biscuit according to claim 1, wherein the texturing, thickening or gelling agent is gelatin or a gelatin substitute.

10. Biscuit according to claim 9, wherein the gelatin substitute is a mixture of xanthan gum, iota-carrageenan and starch.

11. Biscuit according to claim 9, in which the texturing, thickening or gelling agent is present in an amount of 0.5 to 2% by weight, relative to the total wet weight of the binder.

12. A composite ice confectionery comprising a biscuit according to claim 1 in contact with an ice confectionery mass.

13. Composite ice confectionery according to claim 12, in the form of ice sticks or bars or portions in the form of composite slices of the “cassata” type or of domes, in which the biscuit constitutes the core or the coating.

14. Composite ice confectionery according to claim 12, in the form of cakes that have alternate superposed layers of biscuit and of ice confectionery.

15. Composite ice confectionery according to claim 14, in which the cake has on its top surface or on its sides decorative elements of the ice confectionery mass itself.

16. Composite ice confectionery according to claim 12, which further comprises additions or coatings made of a fatty composition, of chocolate or of a covering or sweetened composition for icing, which icing is flavoured, colored or both, in order to confer a visual or taste contrast with the ice confectionery mass.

17. A process for manufacturing a reconstituted biscuit that is extrudable at negative temperatures which comprises:
mixing texturing agents and carbohydrates in water successively or together to form a mixture;
heating the mixture until dissolution is obtained;
pasteurizing the mixture,
adding an overrun-promoting protein to the mixture to prepare a dispersion binder,
freezing the dispersion binder while providing it with a degree of overrun in a freezer, and
incorporating hard or soft biscuit pieces into the frozen overrun binder.

18. Process according to claim 17, wherein the overrun-promoting protein is of milk origin and is added to the mixture prior to pasteurization.

19. Process for manufacturing a composite ice confectionery according to claim 12, in which the biscuit is assembled with the ice confectionery by coextrusion or by successive extrusion of biscuit layers or zones and of ice confectionery, and then the roll assembled is cut into portions.

20. Process according to claim 17, in which the composite ice confectionery is decorated on the continuous assembled band at the same time as the extrusion before cutting the portions or on the cut portions.
